(19) United States
(12) Patent Application Publication
(10) Pub. No.: US 2026/0266424 A1
(43) Pub. Date: Sep. 10, 2026

(54) ACCESSORY APPARATUS

(71) Applicant: CANON KABUSHIKI KAISHA, Tokyo (JP)

(72) Inventors: TAKAZUMI SEO, Tokyo (JP); HIDETOSHI KEI, Tokyo (JP); TOMOKO MORI, Kanagawa (JP)

(21) Appl. No.: 19/552,452

(22) Filed: Feb. 27, 2026

(30) Foreign Application Priority Data
Mar. 10, 2025 (JP) 2025-037706

(51) Int. Cl. F16M 13/06; F16M 11/04; F16M 11/14; F16M 11/28; F16M 13/02; F16M 13/04; G03B 17/56

(52) U.S. Cl. CPC F16M 13/06; F16M 11/041; F16M 11/14; F16M 11/28; F16M 13/022; F16M 13/04; G03B 17/561; F16M 2200/022

(57) ABSTRACT

An accessory apparatus comprising: a body including a plurality of pivotable support legs and that can form a grip portion; a panhead on which an image capturing apparatus can be attached, wherein the plurality of support legs form the grip portion in a first state in which the support legs pivot to close so as to approach one another, and are in contact with a ground contact face in a second state in which the support legs pivot to open so as to separate from one another, and one support leg of the plurality of support legs includes a clamp portion for fixing the body to an attachment target.

### BACKGROUND

### Field of the Technology

The present disclosure relates to an accessory apparatus, more particularly to an accessory apparatus such as a handheld grip tripod to which an image capturing apparatus such as a digital camera can be attached and fixed on the tripod.

### Description of the Related Art

In general, an accessory apparatus such as a handheld grip tripod can handle a shooting scene in a tripod fixed state or a handheld state, but cannot handle a shooting scene in a state of being clamp fixed to an attachment target such as a pillar. Therefore, the user needs to own and carry an accessory specialized in clamp fixing together with the handheld grip tripod in order to handle the shooting scene with clamp fixing to the attachment target.

On the other hand, Japanese Patent Laid-Open No. 05-099397 discloses an accessory that can be hooked and fixed to an upper edge of a door glass of an automobile in addition to use as a tripod (fixed leg) by forming notches in a pair of legs of a tripod for camera.

However, in the technique described in Japanese Patent Laid-Open No. 05-099397, the attachment target for fixing the accessory is limited to a shape and a size that can be hooked by the notches of the legs, and thus versatility of a fixing place is low. Since the accessory is fixed only by hooking the notches to the attachment target, there is a possibility that the accessory may shift or drop when an impact or vibration is applied, and there is a concern in stability.

### SUMMARY

The present disclosure has been made in view of the above problems, and provides a technique for enabling an accessory apparatus usable as a fixed leg or a handheld grip to be stably attached to an attachment target without increasing the size of the accessory apparatus.

According to one aspect pf the present disclosure, there is provided an accessory apparatus comprising: a body including a plurality of pivotable support legs that is pivotable and that can form a grip portion; a panhead on which an image capturing apparatus can be attached, wherein the plurality of support legs form the grip portion in a first state in which the support legs pivot to close so as to approach one another, and are in contact with a ground contact face in a second state in which the support legs pivot to open so as to separate from one another, and one support leg of the plurality of support legs includes a clamp portion for fixing the body to an attachment target.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a perspective view illustrating an outer appearance (folded state) of a grip accessory according to a first embodiment.

FIG. 1B is a perspective view illustrating an outer appearance (opened leg state) of the grip accessory according to the first embodiment.

FIG. 2 is a view illustrating an outer appearance when a camera is attached to the grip accessory according to the first embodiment.

FIG. 3 is an exploded perspective view illustrating a configuration of the grip accessory according to the first embodiment.

FIG. 4 is a partially exploded view illustrating a panhead structure of the grip accessory according to the first embodiment.

FIG. 5A is a view illustrating a configuration (closed state) of a clamp mechanism according to the first embodiment.

FIG. 5B is a view illustrating a configuration (open state) of the clamp mechanism according to the first embodiment.

FIG. 6A is an outer appearance side view of the grip accessory according to the first embodiment.

FIG. 6B is a cross-sectional view illustrating an internal structure of the clamp mechanism according to the first embodiment.

FIGS. 7A and 7B are perspective views illustrating a folding mechanism of a clamp lever of the clamp mechanism according to the first embodiment.

FIG. 8 is a perspective view illustrating an outer appearance structure of the clamp lever according to the first embodiment.

FIG. 9A is a perspective view illustrating an embodiment when an extension and retraction mechanism of the grip accessory according to the first embodiment is used (tripod fixed state).

FIG. 9B is a perspective view illustrating an embodiment when the extension and retraction mechanism of the grip accessory according to the first embodiment is used (handheld grip use state).

FIG. 10A is a front view of the grip accessory according to the first embodiment.

FIG. 10B is a cross-sectional view illustrating the extension and retraction mechanism of the grip accessory according to the first embodiment and an internal arrangement of a clamp portion.

FIGS. 11A to 11E are views illustrating adjustment of an opening angle of a main leg of the clamp mechanism according to the first embodiment.

FIG. 12 is a view illustrating a state in which the grip accessory according to the first embodiment is fixed as a tripod and used.

FIG. 13A is a perspective view illustrating an outer appearance (folded state) of a grip accessory according to a second embodiment.

FIG. 13B is a perspective view illustrating an outer appearance (opened leg state) of the grip accessory according to the second embodiment.

FIG. 14 is an exploded perspective view illustrating a configuration of the grip accessory according to the second embodiment.

FIG. 15 is an exploded perspective view of a main leg forming a clamp portion according to the second embodiment.

FIG. 16 is a view illustrating a shape of the clamp portion according to the second embodiment.

FIGS. 17A to 17D are views illustrating a sliding operation structure of a movable clamp portion according to the second embodiment.

FIGS. 18A to 18C are views illustrating a clamp lock mechanism that restricts the sliding operation of the movable clamp portion according to the second embodiment.

FIGS. 19A to 19C are views illustrating a compact layout of the grip accessory according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

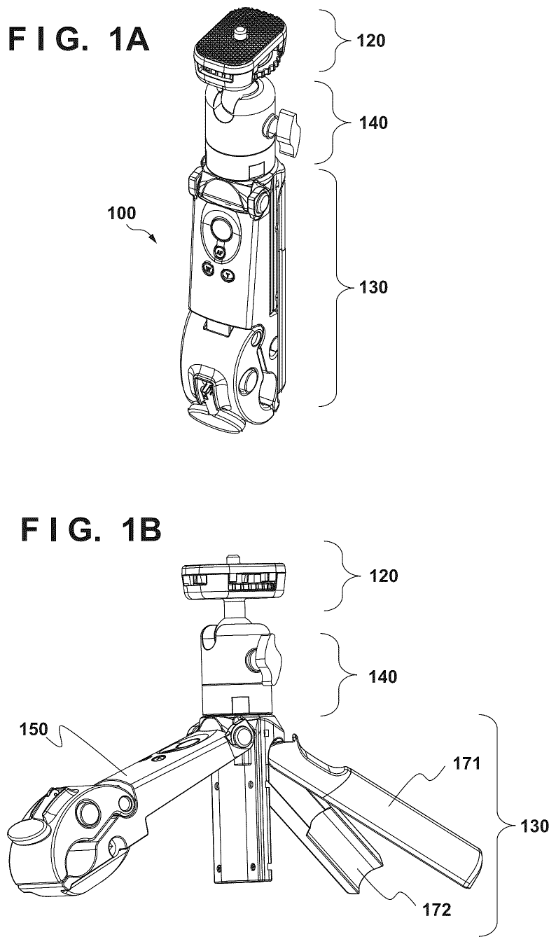

A grip accessory 100, which is an example of an accessory apparatus according to the present embodiment, will be described below with reference to FIGS. 1A to 12.

### Overall Configuration of Grip Accessory

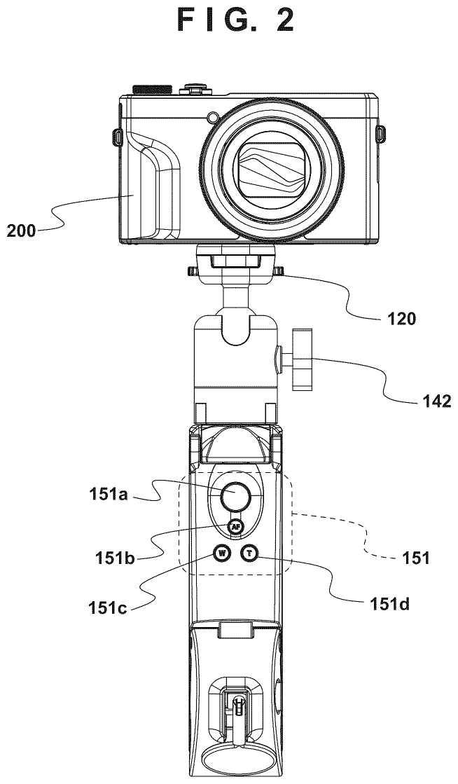

FIGS. 1A and 1B are views illustrating the grip accessory 100 according to the present embodiment. FIG. 1A is a perspective view of the grip accessory 100 used as a handheld grip, and FIG. 1B is a perspective view of the grip accessory 100 used as a tripod. FIG. 1A corresponds to the folded state and FIG. 1B corresponds to the opened leg state. FIG. 2 is a front view illustrating a state in which a camera (image capturing apparatus) 200 is attached to a panhead 120 of the grip accessory 100.

The grip accessory 100 includes the panhead 120 at an upper portion, and can perform shooting by gripping a grip body 130 in a state in which the camera 200 is attached to the panhead 120. The grip body 130 and the panhead 120 of the grip accessory 100 are coupled by a link portion 140. When a lock lever 142 disposed on a side face of the link portion 140 is rotationally operated in a loosening direction, the panhead 120 is freely rotationally moved with respect to the link portion 140, and when the lock lever 142 is rotationally operated in a tightening direction, rotational movement of the panhead 120 is brought into a locked state.

The grip body 130 includes a main leg 150, a first side leg 171, and a second side leg 172, each of which is pivotable, and can form a grip portion. The main leg 150 on which an operation unit 151 (a shooting button 151a, an AF button 151b, and zoom buttons 151c and 151d) that can operate the camera 200 attached to the panhead 120 is disposed is pivotably supported on the front side of the grip body 130. The first side leg 171 and the second side leg 172 formed in a symmetrical shape are pivotably supported on the back side of the grip body 130.

As illustrated in FIG. 1B, the grip accessory 100 opens the main leg 150, the first side leg 171, and the second side leg 172, thereby being grounded at three locations with respect to the ground contact face to be stably supported, and can also be used as a tripod. In this manner, the support legs are grounded to the ground contact face in a state in which the support legs pivot and open so as to separate from each other.

In the present embodiment, the operation unit 151 for operating the camera 200 is built in the main leg 150, but the present disclosure is not limited to this form, and may be configured to be detachable from the main leg 150 so as to be able to perform remote control. In the present embodiment, an example in which a tripod is configured by three support legs of the main leg 150, the first side leg 171, and the second side leg 172 will be described, but the present disclosure is not limited to this form, and the number, shape, and the like of the legs may be changed.

As illustrated in FIG. 2, the operation unit 151 is provided with an operation button for executing a function frequently used by the camera 200. The shooting button 151a is a button for starting/ending a shooting operation. The AF button 151b is a button for driving a focus unit of the camera and adjusting a focus. The zoom buttons 151c and 151d are buttons for operating a lens unit in the wide/tele direction, respectively. The operation unit 151 performs wireless communication with the camera 200 and outputs various control signals to the camera 200. Operability can be improved by providing the operation unit 151 at a position where the user can operate it with his/her thumb when performing shooting while gripping the grip accessory 100. In a case where the operation unit 151 is configured to be detachable for use, the grip accessory 100 is used as a tripod, and the user can perform shooting from a position distant from camera 200.

### Overall Configuration of Grip Body

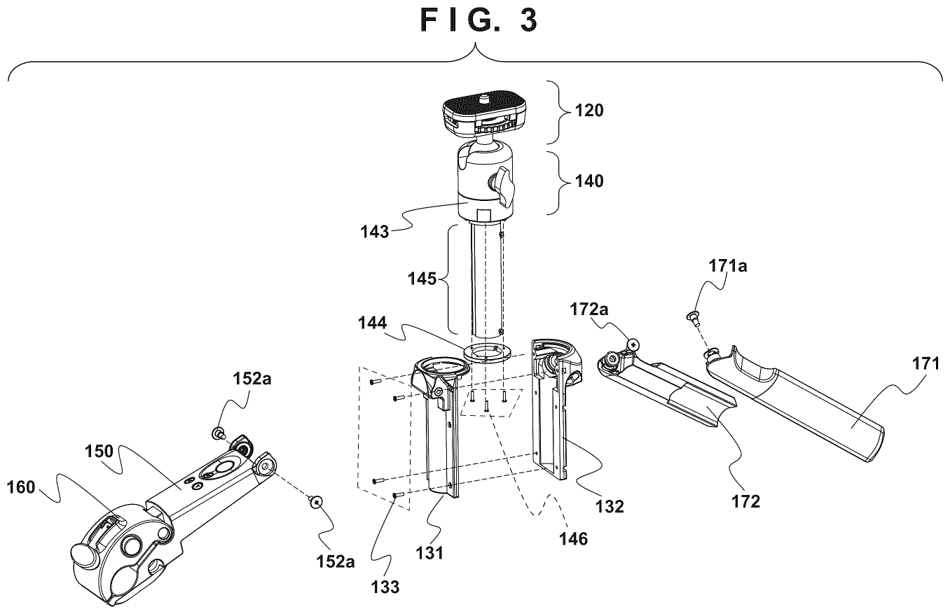

FIG. 3 is an exploded perspective view illustrating the configuration of the grip accessory 100. The grip body 130 includes an extension and retraction portion 145 that can extend and retract in a direction in which the grip body 130 and the panhead 120 separate from or approach each other. A rod cover 143 for holding an extension and retraction portion 145 for extending and retracting the link portion 140 in the top-bottom direction by the method described later is disposed below the link portion 140 that holds the panhead 120. A rotary plate 144 for rotationally holding the link portion 140 is fixed to the bottom surface of the rod cover 143 with screws 146.

The rotary plate 144 is fixed with screws 133 in a form of being sandwiched between a front base cover 131 and a rear base cover 132 from the front-rear direction. At this time, the rotary plate 144 is held rotatably with respect to the front base cover 131 and the rear base cover 132. This makes it possible to perform panning rotation of the portion above the link portion 140, and makes it easy to adjust various angles of view when shooting is performed by the camera 200 fixed to the panhead 120.

The main leg 150 is pivotably attached to the front base cover 131 with stepped screws 152a. The first side leg 171 and the second side leg 172 are pivotably attached to the rear base cover 132 with stepped screws 171a and 172a, respectively. This enables the three legs of the main leg 150, the first side leg 171, and the second side leg 172 to function as a tripod (state of FIG. 1B) when pivoted to open, and to function as a handheld grip (state of FIG. 1A) when closed.

A clamp portion 160 that can fix the grip accessory 100 by nipping the attachment target is disposed at the tip end (end portion on the ground contact face side) of the main leg 150. A detailed structure of the clamp portion 160 will be described later.

### Configurations of Panhead and Link Portion

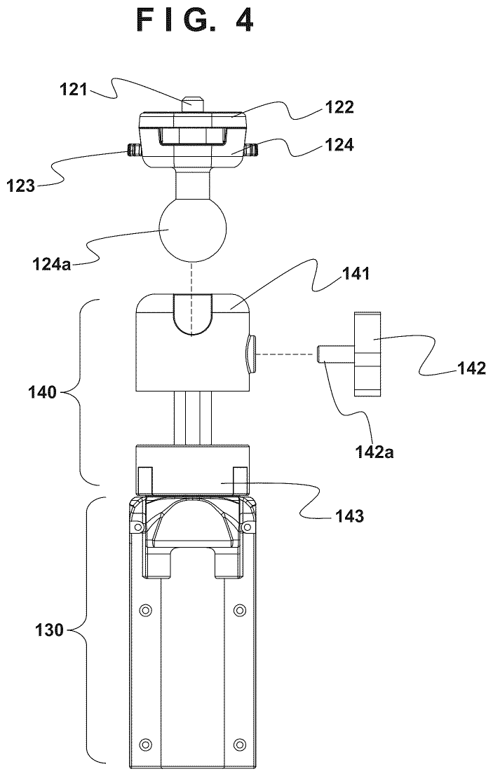

Next, with reference to FIG. 4, a configuration in which the panhead 120 is rotationally moved with respect to the link portion 140 will be described. FIG. 4 is an exploded view illustrating the panhead 120 of the grip accessory 100.

The outer appearance of the panhead 120 is constituted by a top cover 122 and a base holder 124. A tripod screw 121 for attaching the camera 200 is disposed on the top of the top cover 122 so as to protrude. When the camera 200 is mounted, the above-described tripod screw is rotated to perform attachment by operating a rotary dial 123. In the base holder 124, a joint portion 124a having a spherical shape is integrally formed on a side opposing the link portion 140. The joint portion 124a is accommodated in a state of being rotationally movable with respect to a joint holder 141 of the link portion 140 in an assembled state.

The lock lever 142 is held rotatably on a side face of the joint holder 141, and a tip end of the lock lever 142 is configured to be provided with a threaded portion 142a to be movable forward and backward inside the joint holder 141. When the lock lever 142 is operated to be tightened, the tip end of the threaded portion 142a comes into contact with the joint portion 124a, whereby the rotational movement of the panhead 120 can be locked to hold the orientation. In this manner, the configuration of the joint portion 124a makes it possible to fix the camera 200 attached to the panhead 120 at a desired angle to perform shooting.

### Configuration of Clamp Portion

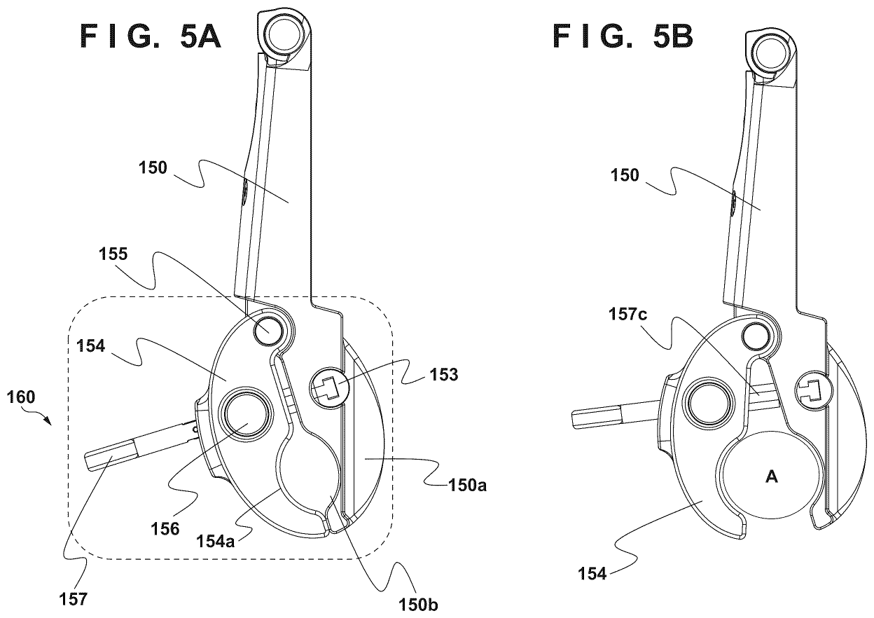

Next, a detailed configuration of the clamp portion 160 according to the present embodiment will be described with reference to FIGS. 5A and 5B to 8. The clamp portion 160 has a function of fixing the grip body 130 to the attachment target. FIGS. 5A and 5B are views illustrating the main leg 150 of the grip body 130. FIG. 5A is a view illustrating a state in which the clamp portion 160 is closed, and FIG. 5B is a view illustrating a state in which the clamp portion 160 is opened to nip an attachment target A (round bar).

As illustrated in FIG. 5A, the clamp portion 160 includes a movable clamp portion 154 and a fixed clamp portion 150a. The movable clamp portion 154 is configured to be pivotable about a pivotal shaft 155 provided in the fixed clamp portion 150a. The fixed clamp portion 150a is integrally formed at the tip end of the main leg 150, and a recess portion 150b having an arc-shaped curved face that functions as one nipping portion when nipping the attachment target A is formed. A recess portion 154a having an arc-shaped curved face that functions as the other nipping portion when nipping the attachment target A together with the recess portion 150b having an arc-shaped curved face described above is formed in the movable clamp portion 154 disposed so as to oppose the fixed clamp portion 150a. In this manner, the clamp portion 160 includes a nipping portion for nipping to fix the attachment target A.

The movable clamp portion 154 is pivotably held about the pivotal shaft 155 with respect to the fixed clamp portion 150a. A clamp lever 157 is rotatably held with respect to the clamp lever holder 153 held by the fixed clamp portion 150a. A male threaded portion 157c is formed on the outer surface of the clamp lever 157, and is held in a state of being engaged with a female threaded portion (not illustrated) formed inside a movable clamp lever holder 156 held by the movable clamp portion 154.

By this, when the clamp lever 157 is rotationally operated counterclockwise from the state (closed state) of FIG. 5A, the movable clamp portion 154 can be opened by the action of the female threaded portion (not illustrated) engaged with the male threaded portion 157c. Furthermore, the attachment target A (round bar) can be nipped as illustrated in FIG. 5B by rotationally operating the clamp lever 157 in the clockwise direction in a state in which the attachment target A is present inside the recess portions 150b and 154a having arc-shaped curved faces.

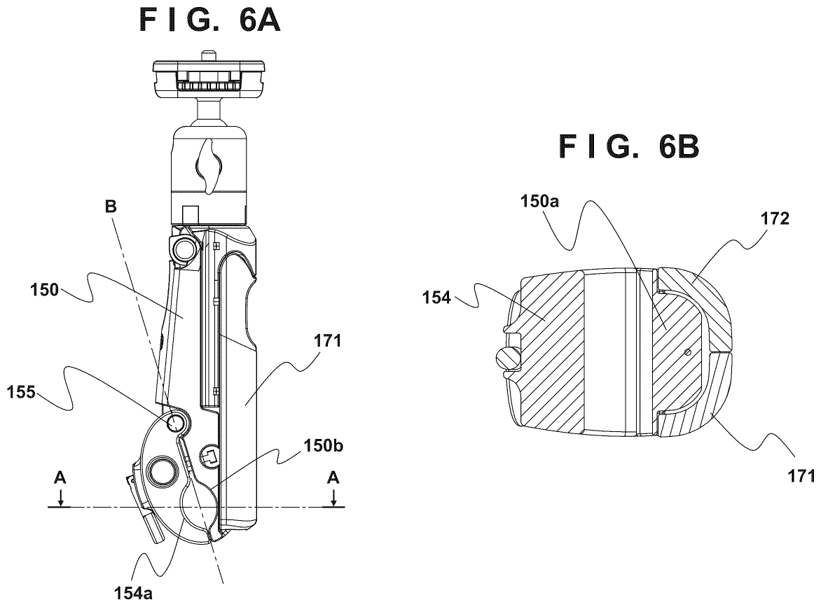

Next, FIG. 6A is an outer appearance side view of the grip accessory 100, and FIG. 6B is a cross-sectional view taken along line A-A in FIG. 6A. In FIG. 6A, a straight line B connecting the center of the pivotal shaft 155 of the clamp portion 160 and the centers of the recess portion 150b and the recess portion 154a having arc-shaped curved faces is disposed so as to be inclined at a constant angle with respect to the extending direction of the main leg 150. In this manner, the straight line B connecting the nipping position of the clamp portion 160 and the pivotal shaft 155 has a certain angle with respect to the extending direction (vertically downward) of the plurality of support legs in a state in which each of the support legs is closed.

As illustrated in the cross-sectional view of FIG. 6B, a part of the shape of the fixed clamp portion 150a of the clamp portion 160 is disposed so as to be included inside the two side legs of the first side leg 171 and the second side leg 172. This makes it possible to provide a shape that is easy to grip when used as a handheld grip by reducing the protrusion amount of the movable clamp portion 154 of the clamp portion 160. It is possible to improve portability by reducing the size of the grip accessory 100 itself.

Furthermore, as illustrated in FIG. 6A, in a state in which the main leg 150, the first side leg 171, and the second side leg 172 pivot to close so as to approach one another, the recess portion 150b and the recess portion 154a, which have arc-shaped curved faces that are nipping portions of the clamp portion 160, are disposed at positions not covered by the first side leg 171 and the second side leg 172. This makes it possible to nip the attachment target A and fix the grip accessory 100, by opening the movable clamp portion 154 in a state of being used as a handheld grip (accommodated state).

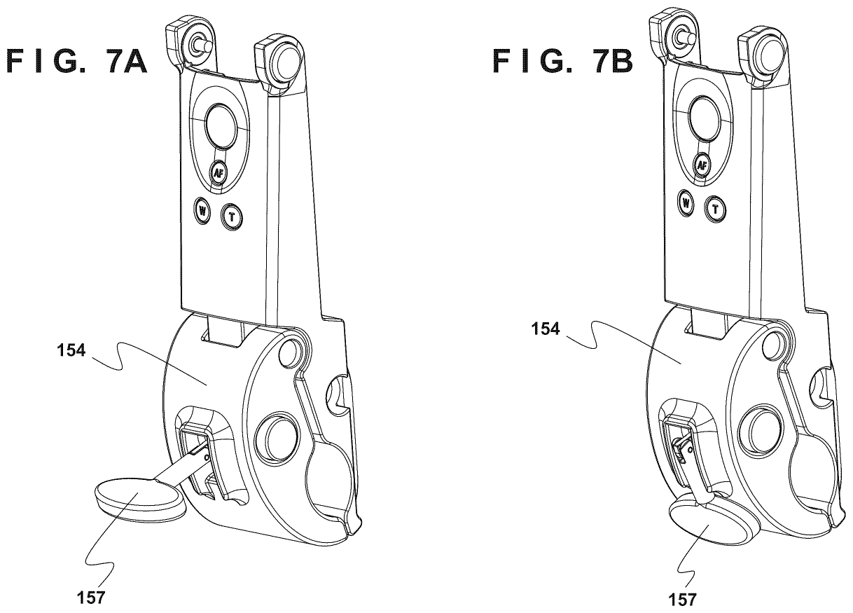

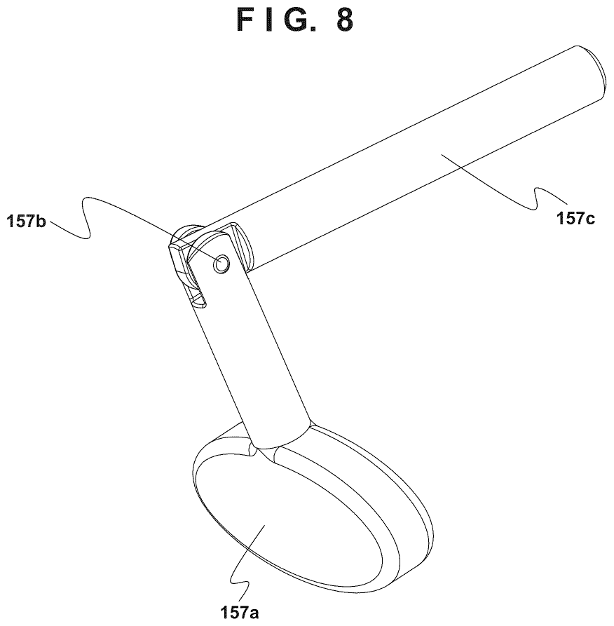

Next, the folding mechanism of the clamp lever 157 will be described with reference to FIGS. 7A, 7B, and 8. FIGS. 7A and 7B are perspective views partially illustrating only the main leg 150 of the grip accessory 100. FIG. 7A illustrates a state in which the clamp lever 157 is opened, and FIG. 7B illustrates a state in which the clamp lever 157 is closed.

In the open state of FIG. 7A, since the clamp lever 157 protrudes outward from the movable clamp portion 154, the movable clamp portion 154 can be pivoted to the open state by pinching an operation unit 157a to perform a rotational operation. In the closed state of FIG. 7B, the clamp lever 157 is folded to be accommodated in the movable clamp portion 154. When the clamp lever 157 is not operated, as illustrated in the drawing, the clamp lever 157 can be accommodated in a state of not protruding from the movable clamp portion 154. Therefore, when the grip accessory 100 is used as a handheld grip, it is possible to prevent the clamp lever 157 from hitting the gripping hand and becoming an obstacle.

In this manner, the clamp portion 160 includes the operation unit 157a for causing the movable clamp portion 154 to perform a pivoting operation with respect to the fixed clamp portion 150a. Then, in response to a rotational operation of the operation unit 157a, it is possible to perform an operation of tightening the movable clamp portion 154 to nip it or an operation of loosening and releasing the movable clamp portion 154 to release the nip. This operation unit 157a is configured to transition between a non-protruding state of not protruding with respect to the clamp portion 160 and a protruding state of protruding with respect to the clamp portion 160.

FIG. 8 is a perspective view illustrating the outer appearance of the clamp lever 157. The clamp lever 157 includes the operation unit 157a, a pivotal shaft 157b, and the male threaded portion 157c in which a screw thread is formed on the outer appearance surface. Here, the operation unit 157a is held rotatably about the pivotal shaft 157b with respect to the male threaded portion 157c. By this, the clamp lever 157 can transition between the opened state (FIG. 7A) and the closed state (FIG. 7B) as described above.

### Extension and Retraction Mechanism of Grip Accessory

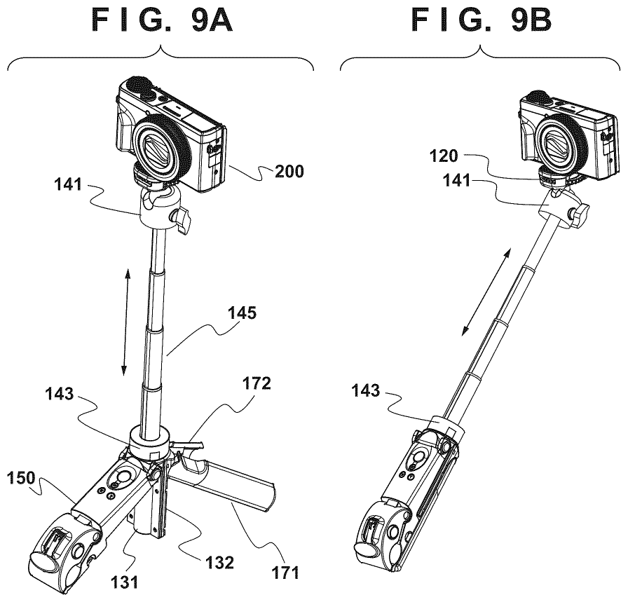

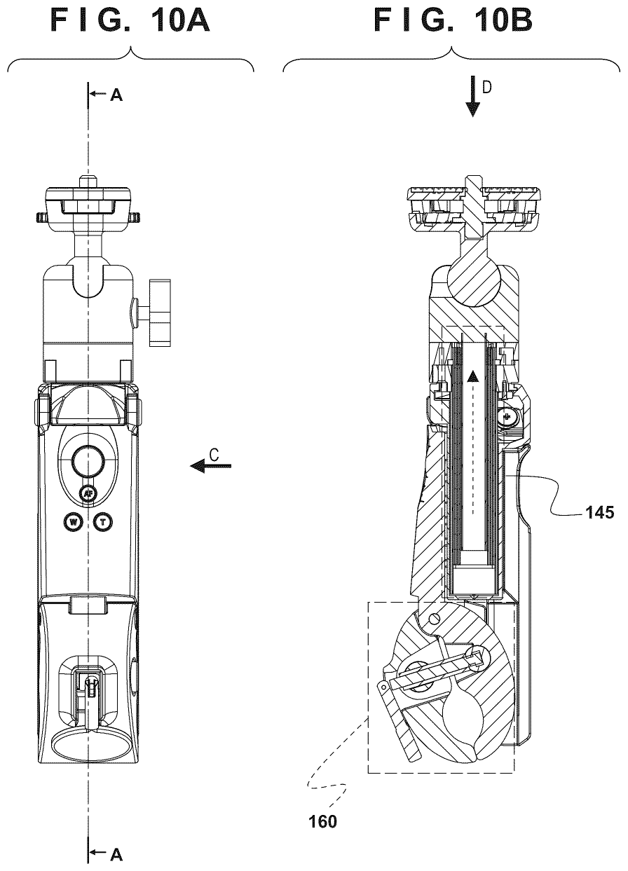

Next, the extension and retraction mechanism of the grip accessory 100 will be described with reference to FIGS. 9A, 9B, 10A, and 10B. FIGS. 9A and 9B are views illustrating an embodiment when the camera 200 attached to the grip accessory 100 extends the extension and retraction mechanism to perform shooting. FIG. 9A illustrates a scene in which shooting is performed with the position of the camera 200 raised in a tripod fixed state, and FIG. 9B illustrates a scene in which shooting is performed with the camera 200 moved away as a handheld grip when a self portrait or the like is performed.

In FIG. 9A, the joint holder 141 and the rod cover 143 are coupled by the extension and retraction portion 145. The extension and retraction portion 145 is configured such that a plurality of metal pipes having different diameters overlap, and can hold a state in which the length is extended and retracted in the arrow direction in the drawing by the overlap thereof and the frictional force. In the present embodiment, the extension and retraction portion 145 is configured by four successive pipes, and the user can use the extension and retraction portion 145 by extending it to an appropriate length. In FIG. 9B, the panhead 120 is rotationally moved with respect to the joint holder 141 by the above-described method, whereby the camera 200 can be fixed at a free angle to perform shooting.

Next, FIGS. 10A and 10B are views illustrating the relationship in arrangement of the extension and retraction portion 145 and the clamp portion 160 in the grip accessory 100. FIG. 10A illustrates a front view of the grip accessory 100, and FIG. 10B illustrates a cross-sectional view taken along line A-A of FIG. 10A. The extension and retraction portion 145 and the clamp portion 160 are arranged in a positional relationship in which they do not overlap when viewed from the direction of arrow C in the drawing and overlap when viewed from the direction of arrow D. In other words, the clamp portion 160 is disposed so as not to overlap with the extension and retraction portion 145 when viewed from a direction orthogonal to the extension and retraction direction of the extension and retraction portion 145 in a state in which each of the support legs is closed. The clamp portion 160 is arranged such that the extension and retraction portion 145 and the clamp portion 160 at least partially overlap in projection when viewed from the extension and retraction direction of the extension and retraction portion 145 in a state in which each of the support legs is closed. The clamp portion 160 is disposed in an opposite direction (lower side in the drawing) to the extension and retraction direction (upper side in the drawing) of the extension and retraction portion 145. This enables the extension and retraction portion 145 and clamp portion 160 to be disposed with respect to the grip accessory 100 with a reduced size.

### Adjustment of Main Leg Opening Angle

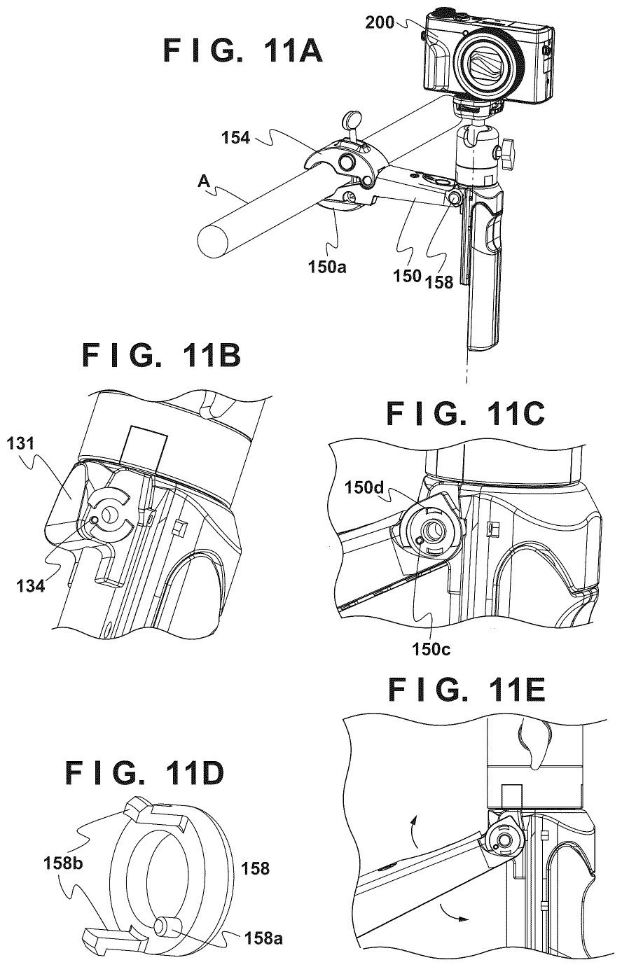

Next, a configuration for adjusting the opening angle of the main leg 150 will be described with reference to FIGS. 11A to 11E. FIG. 11A illustrates the attachment target A nipped and fixed in a state in which the main leg 150 of the grip accessory 100 is opened by 90 degrees from the closed state. In this manner, the main leg 150 including the clamp portion 160 can transition from a state in which the support legs are in contact with the ground to a state in which the support legs pivot to open so as to be further separated and become perpendicular to the main leg 150 when the support legs are in the closed state.

FIG. 11B illustrates a state in which a lock pin 134 protrudes with respect to the front base cover 131. The lock pin 134 is biased in a direction protruding from the front base cover 131 by an internal spring (not illustrated), and is held so as to be able to be pushed in against the spring. FIG. 11C illustrates a state in which the lock pin 134 is engaged with an engaging hole 150c of the main leg 150 in a state in which the main leg 150 is opened in a tripod state. The pivoting operation of the main leg 150 is locked (restricted) by the action of lock pin 134 while keeping a predetermined opening angle in the tripod state. The lock mechanism is thus configured.

FIG. 11D is a perspective view illustrating a structure of a lock release button 158 disposed on the pivotal shaft of the main leg 150. In the lock release button 158, a protruding shape 158a is formed on a face opposing the lock pin 134. A snap fit portion 158b is formed in the lock release button 158, and is locked to a locking hole 150d (FIG. 11C) of the main leg 150.

When the angle is changed from the tripod state, the main leg 150 is pivoted while the lock release button 158 is pressed, whereby the protruding shape 158a of the lock release button 158 pushes the lock pin 134, and the lock of the main leg 150 can be released. According to the method described above, it is possible to pivot the main leg 150 in the direction of the arrow in FIG. 11E. That is, in a case where the restriction of the pivoting operation is released by the lock release button 158, the main leg 150 can pivot from the tripod state to a perpendicular state or the closed state. The action of the lock pin 134 can prevent the opening angle of the main leg 150 from easily changing even when a load is applied from the outside in the tripod state.

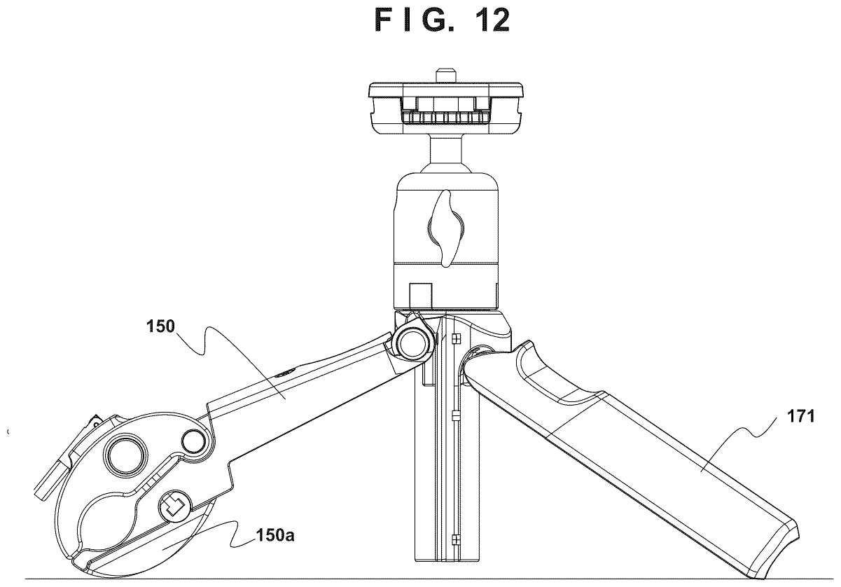

FIG. 12 is a side view in a state in which the grip accessory 100 is fixed as a tripod. In this state, the grip accessory 100 has the three components of the main leg 150, the first side leg 171, and the second side leg 172 grounded with respect to the ground contact face. In the tripod state, a part of the fixed clamp portion 150a is grounded to the ground contact face. In this manner, the stability of the tripod state of the main leg 150 is improved by grounding not the movable clamp portion 154, which is movable, but the fixed clamp portion 150a, which is a fixed portion, to the ground face.

As described above, according to the present embodiment, it is possible to stably attach an accessory apparatus usable as a fixed leg or a handheld grip to an attachment target without increasing the size of the accessory apparatus.

### Second Embodiment

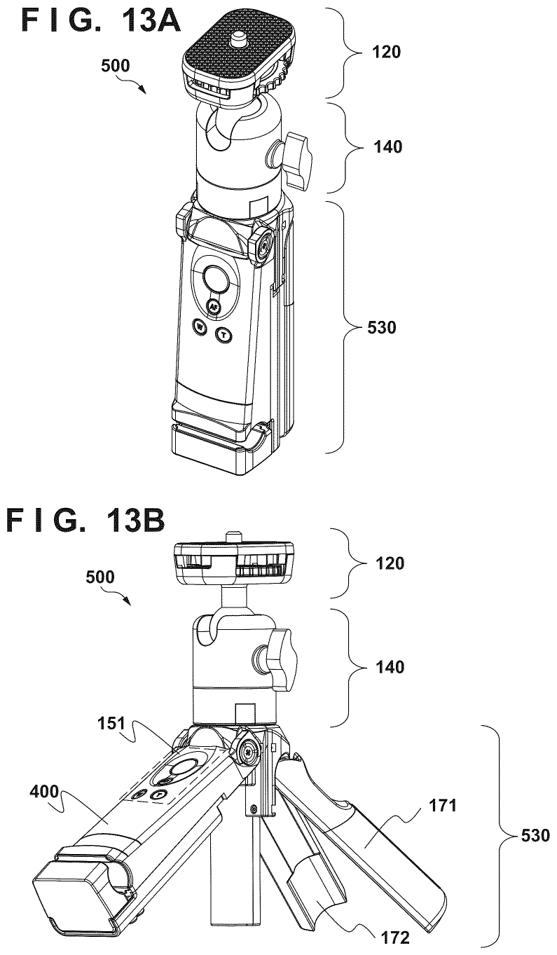

Next, a grip accessory 500, which is an example of an accessory apparatus according to the present embodiment, will be described below with reference to FIGS. 13A to 19C.

### Overall Configuration of Grip Accessory

FIGS. 13A and 13B are views illustrating the grip accessory 500 according to the present embodiment. FIG. 13A is a perspective view of the grip accessory 500, and FIG. 13B is a perspective view of the grip accessory 500 used as a tripod. FIG. 13A corresponds to the folded state and FIG. 13B corresponds to the opened leg state.

The grip accessory 500 includes the panhead 120 at an upper portion, and can perform shooting by gripping a grip body 530 in a state in which the camera 200 (FIG. 2) is attached to the panhead 120. The grip body 530 and the panhead 120 of the grip accessory 500 are coupled by the link portion 140.

The grip body 530 includes a main leg 400, the first side leg 171, and the second side leg 172. The main leg 400 on which the operation unit 151 for performing a camera operation is disposed is pivotably supported on the front side of the grip body 530. The first side leg 171 and the second side leg 172 formed in a symmetrical shape are pivotably supported on the back side of the grip body 530.

As illustrated in FIG. 13B, the grip accessory 500 opens the main leg 400, the first side leg 171, and the second side leg 172, thereby being grounded at three locations with respect to the ground contact face to be stably supported, and can also be used as a tripod. In the present embodiment, the operation unit 151 for performing a camera operation is built in the main leg 400, but the present disclosure is not limited to this form, and may be configured to be detachable from the main leg 400 so as to be able to perform remote control. In the present embodiment, an example in which a tripod is configured by three support legs of the main leg 400, the first side leg 171, and the second side leg 172 will be described, but the present disclosure is not limited to this form, and the number, shape, and the like of the legs may be changed.

### Overall Configuration of Grip Body

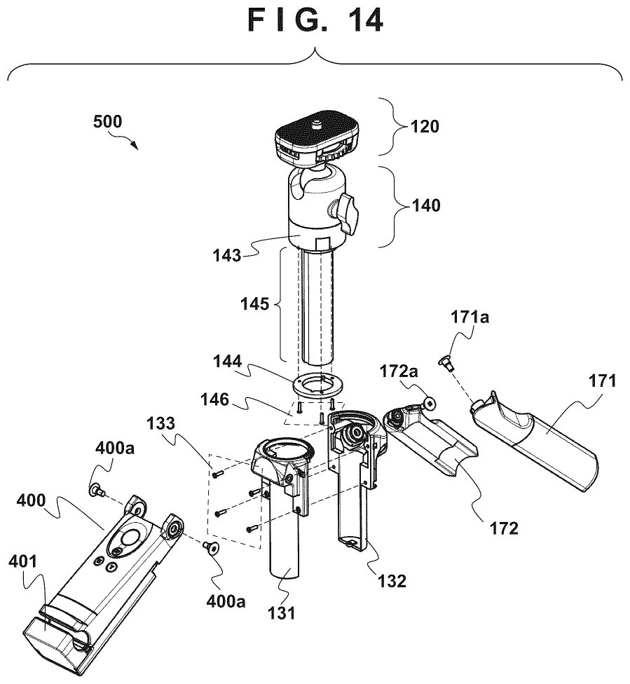

FIG. 14 is an exploded perspective view illustrating the configuration of the grip accessory 500. The rod cover 143 for holding an extension and retraction portion 145 for extending and retracting the link portion 140 in the top-bottom direction is disposed below the link portion 140 that holds the panhead 120. The rotary plate 144 for rotationally holding the link portion 140 is fixed to the bottom surface of the rod cover 143 with screws 146. The rotary plate 144 is fixed with the screws 133 in a form of being sandwiched between the front base cover 131 and the rear base cover 132 from the front-rear direction. At this time, the rotary plate 144 is held rotatably with respect to the front base cover 131 and the rear base cover 132.

The main leg 400 is pivotably attached to the front base cover 131 by stepped screws 400a. The first side leg 171 and the second side leg 172 are pivotably attached to the rear base cover 132 with the stepped screws 171a and 172a, respectively. This enables the three legs of the main leg 400, the first side leg 171, and the second side leg 172 to function as a tripod when pivoted to open, and as a handheld grip when closed.

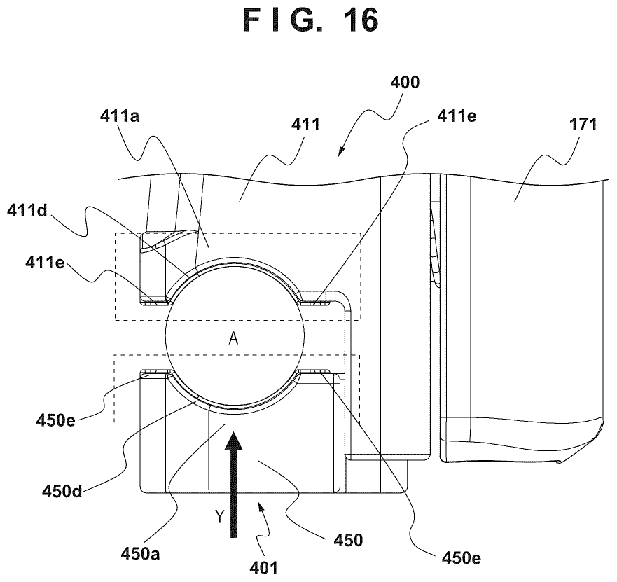

A clamp portion 401 that can fix the grip accessory 500 by nipping the attachment target A (FIG. 16) is disposed at the tip end of the main leg 400. A detailed structure of the clamp portion 401 will be described later.

### Configuration of Clamp Portion

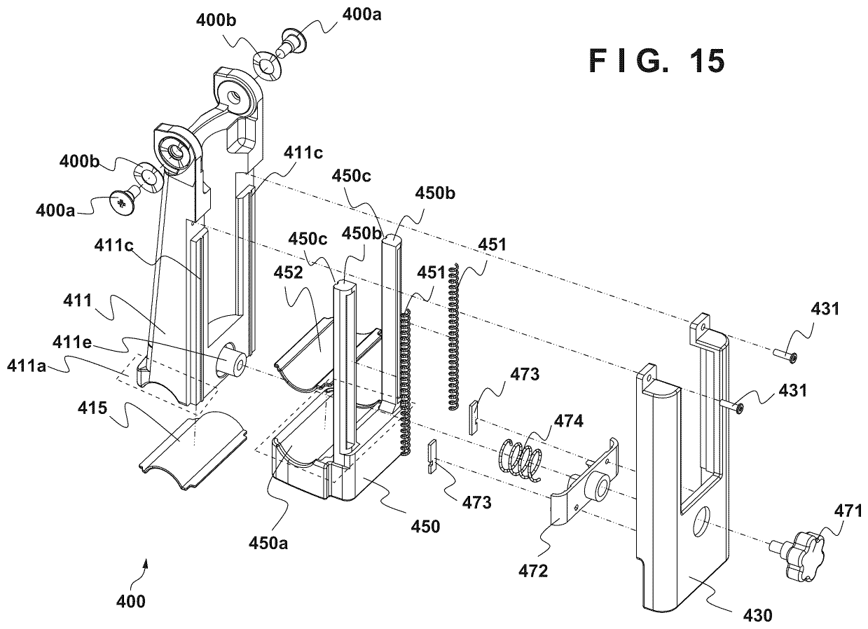

Next, a detailed configuration of the clamp portion 401 according to the present embodiment will be described with reference to FIGS. 15 and 16. FIG. 15 is an exploded perspective view of only the main leg 400 of the grip body 530. The main leg 400 is mainly constituted by a fixed clamp portion 411 and a movable clamp portion 450. A fixed nipping portion 411a functioning as a nipping portion on one side of the clamp portion 401 that nips the attachment target A (FIG. 16) such as a tube or a plate is integrally formed at the tip end of the fixed clamp portion 411. A movable nipping portion 450a that functions as the other nipping portion when nipping the attachment target A (FIG. 16) together with the above-described fixed nipping portion 411a is formed in the movable clamp portion 450 disposed so as to oppose the fixed clamp portion 411.

Here, the shape of the clamp portion 401 will be described with reference to FIG. 16. FIG. 16 illustrates the clamp portion 401 when nipping the attachment target A. The opening shape of the clamp portion 401 is disposed and formed on the outer appearance side of the grip body 530. When the handheld grip is in use, the fixed nipping portion 411a and the movable nipping portion 450a of the clamp portion 401 are disposed at positions not covered by the first side leg 171 and the second side leg 172. This makes it possible to nip the attachment target A (in the arrow Y direction illustrated in FIG. 16) and fix the grip accessory 500, by opening the movable clamp portion 450 (in the direction opposite to arrow Y illustrated in FIG. 16) also when the handheld grip is in use.

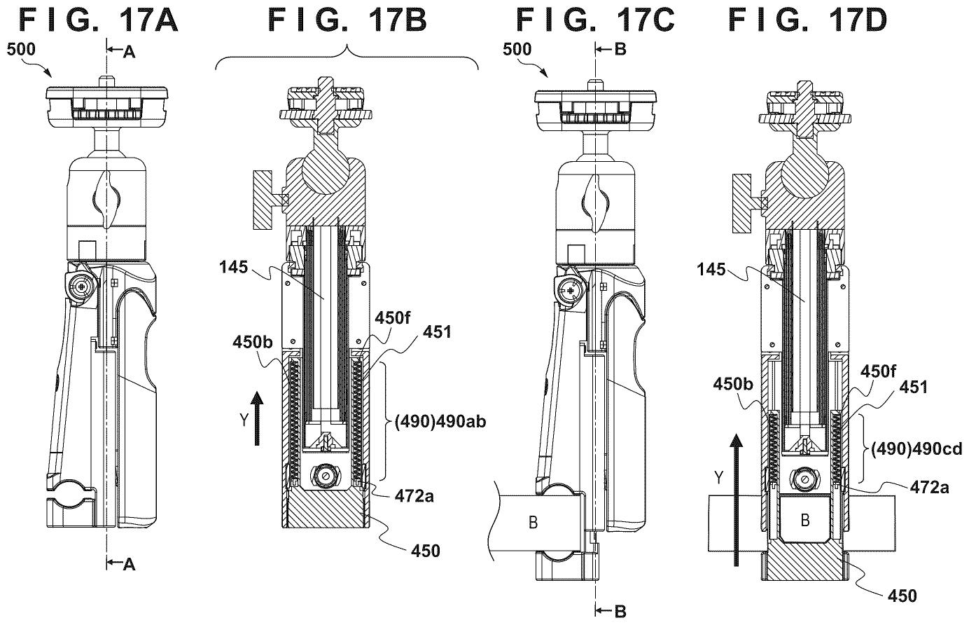

In the present embodiment, the shapes of the fixed nipping portion 411a and the movable nipping portion 450a of the clamp portion 401 include a recess portion 411d having an arc-shaped curved face and a recess portion 450d having an arc-shaped curved face for clamping a round column and the like, and a flat portion 411e and a flat portion 450e for clamping a flat plate and the like on both sides of the recess portions having arc-shaped curved faces. Anti-slip rubber 415 (FIG. 15) and a rubber 452 (FIG. 15) are adhered by a double-sided tape to the fixed nipping portion 411a and the movable nipping portion 450a that nip the attachment target A. Therefore, the clamp portion 401 can clamp various attachment targets such as the attachment target A having a columnar shape such as a pole and an attachment target B having a flat plate shape (FIG. 17C described later) such as a desk.

In the present embodiment, a configuration in which the movable clamp portion 450 is pulled out in the direction (FIG. 16) opposite to arrow Y and the attachment target A is nipped in the arrow Y direction (FIG. 16) has been described, but the present disclosure is not limited to this example. The movable clamp portion 450 may be pulled out in the arrow Y direction (FIG. 16) and the attachment target A may be nipped in the direction (FIG. 16) opposite to arrow Y.

Returning to FIG. 15, a detailed configuration of the main leg 400 will be described. The main leg 400 includes a fixed portion including the fixed clamp portion 411, a rear cover 430, and a movable clamp lock member 472, and a movable portion that is the movable clamp portion 450. The rear cover 430 is formed so as to cover the movable clamp portion 450, and is fastened to the fixed clamp portion 411 with screws 431. The movable clamp lock mechanism will be described in detail later.

The main leg 400 is pivotably attached to the front base cover 131 (FIG. 14) with stepped screws 400a. The side legs 171 and 172 are pivotably attached to the rear base cover 132 (FIG. 14) with the stepped screws 171a and 172a. This enables the three legs of the main leg 400, the first side leg 171, and the second side leg 172 to function as a tripod when pivoted to open, and to function as a handheld grip when closed. In order to consider stability when the tripod is used, the main leg 400 causes not the movable clamp portion 450 but the rear cover 430 (FIG. 15), which is a fixed portion, to be grounded to the ground face. By this, the grip accessory 500 is stably supported at three locations of the main leg 400, the first side leg 171, and the second side leg 172 with respect to the ground contact face, and can also be used as a tripod as in FIG. 13B.

As illustrated in FIG. 15, the movable clamp portion 450 has two symmetrically formed box shapes 450b, which can internally accommodate and dispose a compression spring 451. A recess shape 450c is formed on a face on the fixed clamp portion 411 side of the box shape 450b, and a projected shape 411c is formed on the movable clamp portion 450 side of the fixed clamp portion 411. The movable clamp portion 450 is assembled with respect to the fixed clamp portion 411 such that the recess shape 450c of the movable clamp portion 450 is engaged with the projected shape 411c of the fixed clamp portion 411. This makes it possible to slidably hold the movable clamp portion 450 in the direction in which the main leg 400 extends.

### Sliding Operation

Next, a mechanism of sliding operation of the movable clamp portion 450 will be described with reference to FIGS. 17A to 17D. FIG. 17A is a view illustrating a cross-sectional position of the grip accessory 500 when used as a handheld grip. FIG. 17B is a cross-sectional view taken along line A-A of the grip accessory 500 of FIG. 17A. FIG. 17C is a view illustrating a cross-sectional position of the grip accessory 500 when the attachment target B is clamped. FIG. 17D is a cross-sectional view taken along line B-B of the grip accessory 500 of FIG. 17C.

In the grip accessory 500 according to the present embodiment, the compression spring 451 that biases the movable clamp portion 450 in an accommodation direction (arrow Y direction illustrated in FIG. 17B) is disposed in the two box shapes 450b symmetrically disposed. The compression spring 451 is disposed in a space 490 between a box shape upper portion 450f of the movable clamp portion 450 and a projection portion 472a formed on the movable clamp lock member 472.

In the grip accessory 500, the movable clamp portion 450 is manually slid in a bottom surface extending direction of the main leg 400 (direction opposite to arrow Y illustrated in FIG. 17B), and nips the attachment target B using the biasing force of the compression spring 451 (arrow Y direction illustrated in FIG. 17B). At this time, in the space 490, a space 490cd (FIG. 17D) at the time of clamping is narrower than a space 490ab (FIG. 17B) when used as a handheld grip. The compression spring 451 disposed in the space 490 is movably held inside the box shape 450b with the projection portion 472a formed on the movable clamp lock member 472 as a fixed face.

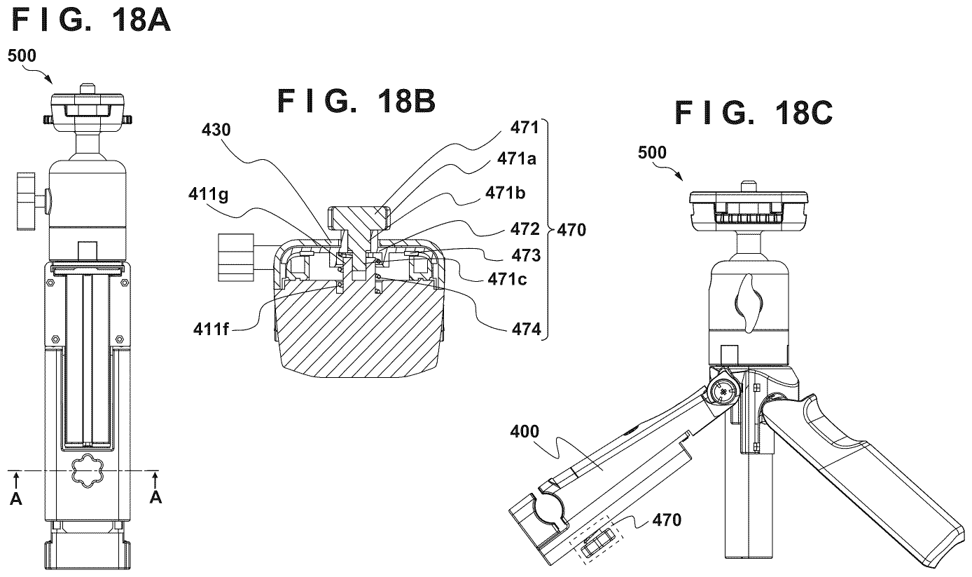

As illustrated in FIG. 17D, when the attachment target B is nipped, the movable clamp portion 450 is constantly biased in a direction in which the clamp is tightened by the compression spring 451 (arrow Y direction illustrated in FIG. 17D). However, there is a possibility that the fixing by the clamp cannot be sufficiently performed only by the biasing force of the compression spring 451. Therefore, in the present embodiment, a clamp lock mechanism 470 (FIG. 18) that restricts the sliding operation of the movable clamp portion 450 after clamping is provided.

### Configuration of Clamp Lock Mechanism

Next, a detailed structure of the clamp lock mechanism 470 will be described with reference to FIGS. 15 and 18A to 18C. FIGS. 18A to 18C are views illustrating the clamp lock mechanism 470 that restricts the sliding operation of the movable clamp portion 450. FIG. 18A is a view illustrating a cross-sectional position of the grip accessory 500 when used as a handheld grip. FIG. 18B is a cross-sectional view taken along line A-A of the grip accessory 500. FIG. 18C is a right side view of the grip accessory 500 when used as a tripod.

The clamp lock mechanism 470 is provided on the main leg 400 in which the clamp is constituted, and is disposed below the grip accessory 500 avoiding the extension and retraction portion 145 and so as to be included in the grip in the handheld grip state. In other words, the clamp lock mechanism 470 is disposed so as to be included in the support legs in a state in which the support legs are closed. The clamp lock mechanism 470 is disposed at a position where it is not grounded to the ground face when used as a tripod as illustrated in FIG. 18C.

The clamp lock mechanism 470 includes a clamp lock operation unit 471 for moving the movable clamp lock member 472 to a lock position, the movable clamp lock member 472 that fixes the movable clamp portion 450, rubber 473, and a compression spring 474. The position of the compression spring 474 is determined using a recess shape 411f formed in the fixed clamp portion 411 and the outer diameter of a screw seat 411g. The recess shape 411f and the screw seat 411g are formed on the movable clamp portion 450 side and at a lower portion of the recess shape avoiding the extension and retraction portion 145.

The position of the movable clamp lock member 472 is determined together with the rear cover 430, and is constantly biased on the rear cover 430 side by the compression spring 474. Therefore, the movable clamp portion 450 can slide without interfering with the movable clamp lock member 472. The clamp lock operation unit 471 includes an operation unit 471a and two shafts 471b and 471c coaxial with the operation unit 471, and a lower surface of the operation unit 471a and a tubular upper surface of the movable clamp lock member 472 are in contact with each other.

The position of the clamp lock operation unit 471 is restricted based on the outer shape of the first shaft 471b and the tubular inner diameter of the movable clamp lock member 472. A male screw thread is formed on the second shaft 471c of the clamp lock operation unit 471, and is screwed into the screw seat 411g of the fixed clamp portion 411. Therefore, rotating the clamp lock operation unit 471 clockwise increases the screw engagement amount, and the movable clamp lock member 472 nips the movable clamp portion 450. Anti-slip rubber 473 is affixed to a location of the movable clamp lock member 472 that comes into contact with the movable clamp portion 450, and the sliding operation of the movable clamp portion 450 can be restricted by the clamp lock mechanism 470 without slipping. In this manner, the movable clamp portion 450 can be switched between the fixed state and the movable state in response to the rotational operation of the clamp lock operation unit 471.

### Compact Layout

The grip accessory 500 according to the present embodiment is a multifunctional accessory apparatus having a handheld grip function, a tripod function by the main leg 400, the first side leg 171, and the second side leg 172, a height adjustment function by the extension and retraction portion 145, and a clamping function by the clamp portion 401. In general, if the height adjustment function or the clamp function is added in addition to the handheld grip function or the tripod function, there is a concern that the number of components increases and the size of the accessory apparatus increases.

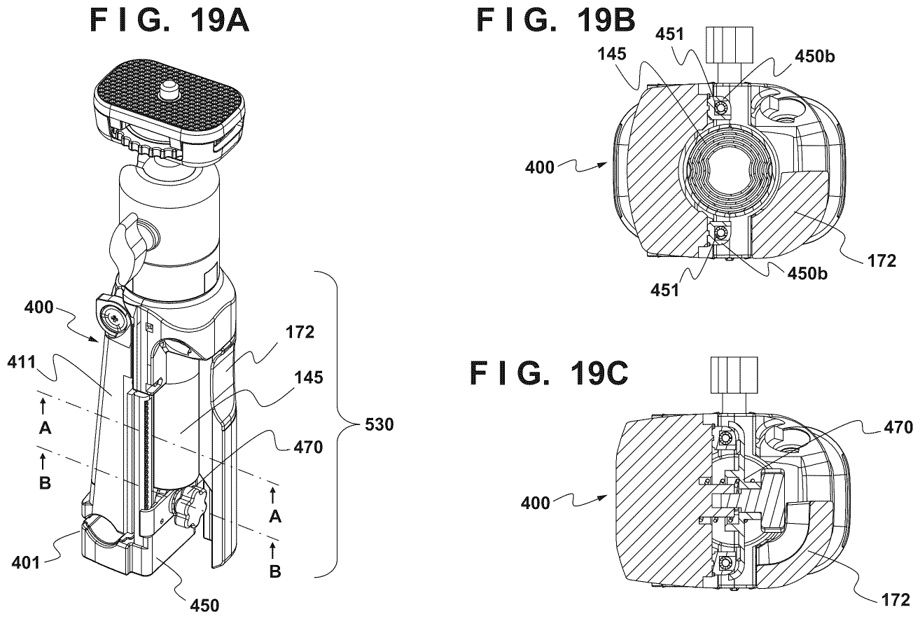

A compact layout of the grip accessory 500 according to the present embodiment will now be described with reference to FIGS. 19A to 19C. FIG. 19A is a back perspective view of the grip accessory 500 when used as a handheld grip. FIG. 19B is a cross-sectional view taken along line A-A of FIG. 19A, and FIG. 19C is a cross-sectional view taken along line B-B of FIG. 19A. FIGS. 19A to 19C are views in which the first side leg 171 and the rear cover 430 are removed from the grip accessory 500 for the sake of description.

As illustrated in FIG. 19B, the extension and retraction portion 145 is disposed at the center of the grip body 530, and the main leg 400 and the second side leg 172 are disposed so as to avoid the extension and retraction portion 145. The compression spring 451 and the box shape 450b, which are sliding operation mechanisms of the movable clamp portion 450, are disposed on both sides of the extension and retraction portion 145. As illustrated in FIG. 19C, the clamp lock mechanism 470 is disposed below the extension and retraction portion 145 and in a space surrounded by the main leg 400, the first side leg 171, and the second side leg 172. That is, a part of the shape of the main leg 400 constituting the clamp portion 401 is disposed to enter into the first side leg 171 and the second side leg 172 which are the two side legs.

This makes it possible to avoid an increase in size of the grip accessory 500 due to the main leg 400 equipped with the clamp portion 401, the sliding operation mechanism of the movable clamp portion 450, the clamp lock mechanism 470, and the like, and provide a shape that can be easily gripped when used as a handheld grip. The movable clamp portion 450 is held slidably in a direction in which the main leg 400 extends with respect to the fixed clamp portion 411. In the present embodiment, the movable clamp portion 450 is held by the fixed clamp portion 411 such that the movable clamp portion 450 is slidable in the direction in which the main leg 400 extends. This provides a configuration in which the grip body 530 does not increase in size in a handheld grip state even in a case of being equipped with the clamp mechanism.

As described above, according to the present embodiment, it is possible to stably attach an accessory apparatus usable as a fixed leg or a handheld grip to an attachment target without increasing the size of the accessory apparatus.

According to the present disclosure, it is possible to stably attach an accessory apparatus usable as a fixed leg or a handheld grip to an attachment target without increasing the size of the accessory apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037706, filed Mar. 10, 2025, which is hereby incorporated by reference herein in its entirety.

What is claimed is:

1. An accessory apparatus comprising:
a body including a plurality of pivotable support legs and that can form a grip portion;
a panhead on which an image capturing apparatus can be attached, wherein
the plurality of support legs
form the grip portion in a first state in which the support legs pivot to close so as to approach one another, and
are in contact with a ground contact face in a second state in which the support legs pivot to open so as to separate from one another, and
one support leg of the plurality of support legs includes a clamp portion for fixing the body to an attachment target.

2. The accessory apparatus according to claim 1, wherein
the clamp portion includes a nipping portion for nipping and fixing the attachment target, and
the nipping portion is disposed at a position not covered by the plurality of support legs in the first state.

3. The accessory apparatus according to claim 1, wherein the support leg including the clamp portion pivots to open such that the support legs further separate from one another from the second state, and can transition to a third state in which the support leg is perpendicular to the support leg in the first state.

4. The accessory apparatus according to claim 3, wherein
the support leg including the clamp portion includes
a lock mechanism unit configured to restrict a pivoting operation in the second state, and
a lock release unit disposed on a pivotal shaft of the support leg including the clamp portion, and
is pivotable from the second state to the third state or the first state in a case where the restriction on the pivoting operation is released by the lock release unit.

5. The accessory apparatus according to claim 1, wherein a part of the clamp portion is disposed so as to be included inside another support leg not including the clamp portion in the first state.

6. The accessory apparatus according to claim 1, wherein the support leg including the clamp portion includes an operation unit configured to enable operation of the image capturing apparatus to be attached to the panhead.

7. The accessory apparatus according to claim 1, wherein the body includes an extension and retraction portion extendable and retractable in a direction in which the body and the panhead are separated from or approach each other.

8. The accessory apparatus according to claim 7, wherein the clamp portion is disposed so as not to overlap with the extension and retraction portion as viewed from a direction orthogonal to an extension and retraction direction of the extension and retraction portion in the first state.

9. The accessory apparatus according to claim 7, wherein the clamp portion is disposed such that the extension and retraction portion and the clamp portion at least partially overlap as viewed in an extension and retraction direction of the extension and retraction portion in the first state.

10. The accessory apparatus according to claim 1, wherein the clamp portion is disposed at an end portion of the support leg including the clamp portion on a side of the ground contact face.

11. The accessory apparatus according to claim 1, wherein
the clamp portion includes a movable clamp portion and a fixed clamp portion,
the movable clamp portion is configured to be pivotable about a pivotal shaft provided in the fixed clamp portion, and
the fixed clamp portion is formed integrally with the one support leg of the plurality of support legs.

12. The accessory apparatus according to claim 11, wherein a straight line connecting a nipping position of the clamp portion and the pivotal shaft has a constant angle with respect to an extending direction of the plurality of support legs in the first state.

13. The accessory apparatus according to claim 11, wherein
the clamp portion includes an operation unit for causing the movable clamp portion to perform a pivoting operation with respect to the fixed clamp portion, and
an operation of tightening the movable clamp portion to perform nipping or an operation of loosening the movable clamp portion to release nip is performed in response to a rotational operation of the operation unit.

14. The accessory apparatus according to claim 13, wherein the operation unit is configured to transition between a non-protruding state of not protruding with respect to the clamp portion and a protruding state of protruding with respect to the clamp portion.

15. The accessory apparatus according to claim 11, wherein a part of the fixed clamp portion is grounded to the ground contact face in the second state.

16. The accessory apparatus according to claim 1, wherein
the clamp portion includes a nipping portion for nipping and fixing the attachment target,
the nipping portion includes a recess portion having an arc-shaped curved face and flat portions formed on both sides of the recess portion, and
the clamp portion is formed on an outer appearance side of the support leg including the clamp portion.

17. The accessory apparatus according to claim 1, wherein
the clamp portion includes a movable clamp portion and a fixed clamp portion, and
the movable clamp portion is held by the fixed clamp portion so as to be slidable with respect to the fixed clamp portion in a direction in which the support leg including the clamp portion extends.

18. The accessory apparatus according to claim 17, wherein
the support leg including the clamp portion includes a clamp lock mechanism unit configured to restrict a sliding operation of the movable clamp portion, and
the clamp lock mechanism includes
a lock member that fixes the movable clamp portion, and
an operation unit configured to move the lock member to a lock position, and
can switch the movable clamp portion between a fixed state and a movable state in response to a rotational operation of the operation unit.

19. The accessory apparatus according to claim 18, wherein the clamp lock mechanism is disposed so as to be included in the plurality of support legs in the first state.

20. The accessory apparatus according to claim 1 further comprising a link portion coupling the body and the panhead.
